(19) United States
(12) Patent Application Publication
(10) Pub. No.: US 2024/0333895 A1
(43) Pub. Date: Oct. 3, 2024

(54) PROJECTION CONTROL DEVICE, PROJECTION SYSTEM, PROJECTION CONTROL METHOD, AND RECORDING MEDIUM

(71) Applicant: CASIO COMPUTER CO., LTD., Tokyo (JP)

(72) Inventor: Teruo SANO, Tokyo (JP)

(21) Appl. No.: 18/624,875

(22) Filed: Apr. 2, 2024

(30) Foreign Application Priority Data
Apr. 3, 2023 (JP) 2023-060049

(51) Int. Cl. H04N 9/31

(52) U.S. Cl. CPC H04N 9/3185

(57) ABSTRACT

A projection control device includes a processor to determine a projection region, based on image information of a projection plane and determine a layout of a projection content to be projected in the projection region according to at least a shape of the determined projection region.

### CROSS-REFERENCE TO RELATED APPLICATIONS

This application claims the benefit of Japanese Patent Application No. 2023-060049, filed on Apr. 3, 2023, the entire disclosure of which is incorporated by reference herein.

### FIELD OF THE INVENTION

The present disclosure relates to a projection control device, a projection system, a projection control method, and a non-transitory computer-readable recording medium.

### BACKGROUND OF THE INVENTION

A system to not only project an image and the like but also project information assisting work performed by a user by a projector and to improve work efficiency of the user has been developed. For example, in Unexamined Japanese Patent Application Publication No. 2013-254437, an image processing device and the like that projects work assistance information for assisting information entry work using a document, based on a position of the document in an imaging region is disclosed.

### SUMMARY OF THE INVENTION

A projection control device according to the present disclosure includes a processor to execute processing including:
determining a projection region, based on image information of a projection plane; and
determining a layout of a projection content to be projected in the projection region according to at least a shape of the determined projection region.

### BRIEF DESCRIPTION OF DRAWINGS

A more complete understanding of this application can be obtained when the following detailed description is considered in conjunction with the following drawings, in which:

FIG. 1 is a diagram illustrating an installation example of a projection system according to embodiments;

FIG. 2 is a diagram illustrating a connection example of devices constituting the projection system according to the embodiments;

FIG. 3 is a diagram illustrating an example of a functional configuration of the projection system according to the embodiments;

FIG. 4 is a diagram illustrating an example of a horizontally long projection content;

FIG. 5 is a diagram illustrating an example of a vertically long projection content;

FIG. 6 is a diagram illustrating an example of a small projection content;

FIG. 7 is a diagram for a description of a relationship among a work table, a work object, a plane region, and a projection region;

FIG. 8 is a diagram illustrating an example in which a horizontally long projection content is projected in a vertically long projection region;

FIG. 9 is a diagram illustrating an example in which a vertically long projection content is projected in the vertically long projection region;

FIG. 10 is a diagram illustrating an example of data structure of projection contents according to Embodiment 1;

FIG. 11 is an example of a flowchart of projection control processing according to Embodiment 1;

FIG. 12 is an example of a flowchart of layout extraction processing according to Embodiment 1;

FIG. 13 is an example of a flowchart of layout determination processing according to Embodiment 1;

FIG. 14 is a diagram illustrating an example of data structure of a projection content according to Embodiment 2;

FIG. 15 is an example of a flowchart of projection control processing according to Embodiment 2;

FIG. 16 is an example of a flowchart of gesture recognition processing according to Embodiment 2;

FIG. 17 is an example of a flowchart of projection control processing according to Embodiment 3;

FIG. 18 is a diagram illustrating an example in which a projection content represented by text data is projected in a vertically long projection region in a reflow form; and

FIG. 19 is a diagram illustrating an example in which a projection content represented by text data is projected in a horizontally long projection region in the reflow form.

### DETAILED DESCRIPTION OF THE INVENTION

A projection system and the like according to embodiments are described below with reference to the drawings. Note that, in the drawings, the same or equivalent constituent elements are designated by the same reference numerals.

### Embodiment 1

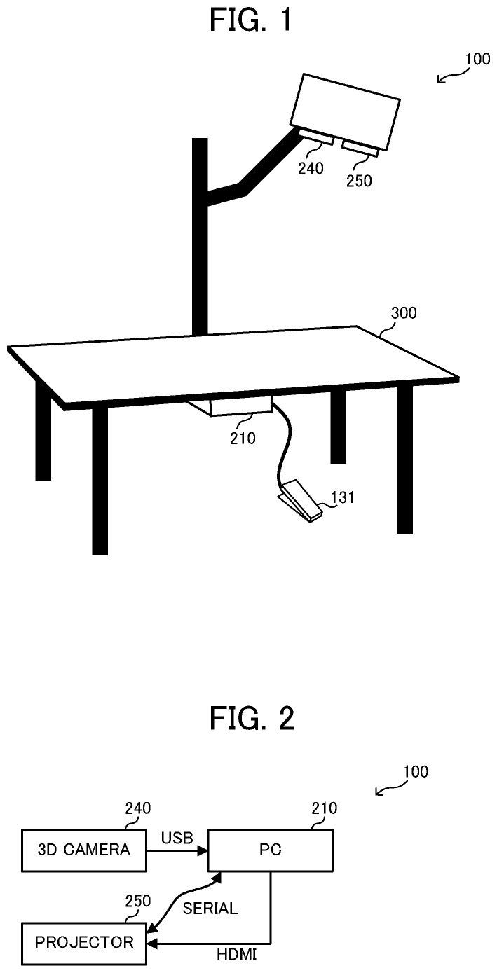

A projection system 100 according to Embodiment 1 has a configuration in which a three-dimensional (3D) camera 240 and a projector 250 are installed above a work table 300 and a personal computer (PC) 210 and a foot switch 131 are installed below the work table 300, as illustrated in, for example, FIG. 1. The projection system 100 is a system that is controlled by the PC 210, that detects a plane (a region in which none of a work object, a hand of a user, and the like exists) on the work table 300 by the 3D camera 240, and that projects a projection content on the plane by the projector 250. Therefore, the PC 210 is also referred to as a projection control device.

The projection system 100 has a configuration in which, to the PC 210, the 3D camera 240 is connected via a universal serial bus (USB) and the projector 250 is connected via a high-definition multimedia interface (HDMI) (registered trademark) or a serial cable, as illustrated in, for example, FIG. 2.

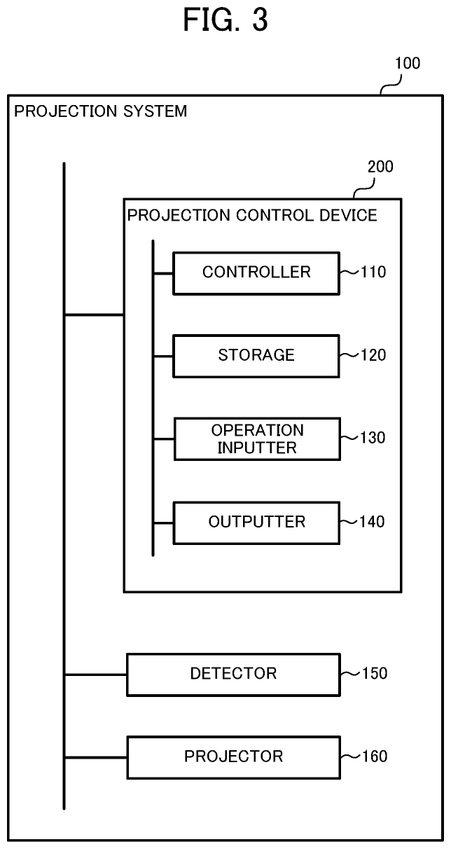

The projection system 100 and a projection control device 200 has a functional configuration in which, as illustrated in FIG. 3, the projection control device 200 includes a controller 110, a storage 120, an operation inputter 130, and an outputter 140 and the projection system 100 includes, in addition to the foregoing, a detector 150 and a projector 160. For example, the PC 210 serving as the projection control device 200 corresponds to the controller 110, the storage 120, the operation inputter 130, and the outputter 140, the 3D camera 240 corresponds to the detector 150, and the projector 250 corresponds to the projector 160.

However, which device among the devices that the projection system 100 includes is caused to correspond to the respective functional constituent units described above can be arbitrarily determined. For example, instead of causing the projection control device 200 to correspond to the operation inputter 130 and the outputter 140, the projector 250 may be caused to correspond to the operation inputter 130, the outputter 140, and the projector 160.

The controller 110 includes a processor, such as a central processing unit (CPU). The controller 110 executes processing to achieve various types of functions of the projection system 100, projection control processing, which is described later, and the like, by a program stored in the storage 120. In addition, the controller 110 includes a timer function and is capable of measuring time. In addition, the controller 110 has a capability of performing multithread processing and is capable of executing a plurality of pieces of processing in parallel.

The storage 120 stores programs that the controller 110 executes and data required for the execution. The storage 120 may include a random access memory (RAM), a read only memory (ROM), a flash memory, or the like, but not limited thereto. Note that the storage 120 may be installed inside the controller 110.

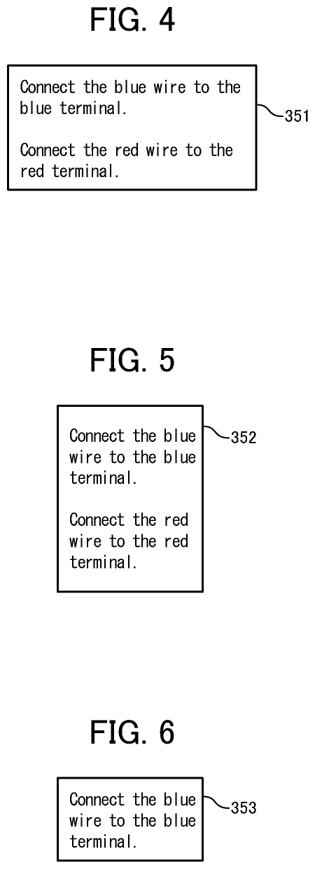

In addition, the storage 120 stores image data of a work guide as illustrated in, for example, FIGS. 4, 5, and 6 as information of a projection content. Each of the work guides illustrated in FIGS. 4, 5, and 6 is an example of a work guide to assist work of connecting a cable (wire) to a terminal, and a plurality of layouts, although including the same content, matching various shapes of a region in which a projection content is projected is prepared. For example, FIGS. 4, 5, and 6 illustrate examples of a projection content 351 in a horizontally long layout, a projection content 352 in a vertically long layout, and a projection content 353 in a small layout, respectively.

The operation inputter 130 includes user interfaces, such as a keyboard, a mouse, and a foot switch 131 illustrated in FIG. 1 and accepts operation input from the user.

The outputter 140 is a device that outputs sound information, optical information, character information, and the like and includes an output device, such as a speaker, a light emitting diode (LED), and a display. The outputter 140 is used to output an alarm to the user when a trouble, such as the projector 160 being unable to project a projection content, occurs. Since it is sufficient for the outputter 140 to be able to output an alarm to the user, the outputter 140 does not have to include all the above-described output devices, and the outputter 140 is only required to include, for example, at least one of the speaker, the LED, the display, and the like.

The detector 150 includes a range sensor and acquires a state of an upper surface of the work table 300 (information about three-dimensional positions of a plurality of points on the upper surface). The controller 110 is capable of acquiring information that the detector 150 acquired (position information of the plurality of points on the upper surface of the work table 300) and, based on the information acquired from the detector 150, detecting which area on the upper surface is planar or which area is not planar (whether or not an unevenness exists) and the like. Note that although in the example illustrated in FIG. 1, the projection system 100 is assumed to use the 3D camera 240 as the detector 150, the detector 150 does not necessarily have to use the 3D camera 240 as the range sensor. The detector 150 can use an arbitrary sensor as long as the sensor is capable of acquiring information to detect a planar region.

The projector 160 is the projector 250 (projection device) and includes a light source, a projection device, a lens unit, and the like. Although types of the light source, the projection device, and the like can be arbitrarily chosen, it is assumed that a digital mirror device (DMD) is used as the projection device in the present embodiment. Although a shape and aspect ratio of a projected image can also be arbitrarily chosen, a projected image is assumed to be a horizontally long rectangle with an aspect ratio of 16:10 in the present embodiment.

In addition, in the projection system 100, after the projection system 100 is installed on the work table 300 or the like, calibration processing is performed in order to match a coordinate system of the projector 160 (a DMD coordinate system) with a coordinate system of the detector 150 (a camera coordinate system).

Although in what manner the calibration processing is performed can be arbitrarily determined, for example, first, a check image of a checkered pattern is projected on the upper surface of the work table 300 by the projector 160 (the projector 250), and a projected image is captured by the detector 150 (the 3D camera 240). The controller 110 acquires correspondence relations between coordinates of respective intersection points in the captured image (camera coordinates) and coordinates of respective intersection points in the original check image (DMD coordinates). By using the correspondence relations, the projection system 100 is enabled to find what image (image represented in the DMD coordinate system) is required to be projected in order to perform projection in some region (region represented in the camera coordinate system) on the work table 300.

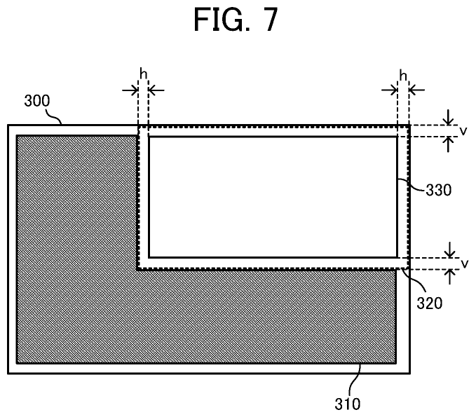

In the present embodiment, it is assumed that after the projection system 100 is installed, the user performs the above-described calibration processing and subsequently places a work object 310 on the work table 300 and starts work. During the work, a plane region 320 in which the work object 310 does not exist on the work table 300 is produced, as illustrated in FIG. 7. The controller 110 detects the plane region 320, using the detector 150 by, for example, a detection method described in Unexamined Japanese Patent Application Publication No. 2014-85940. The projection system 100 determines, as a projection region 330, a region obtained by excluding, from a largest rectangular region inscribed in the plane region 320 (in the example illustrated in FIG. 7, the rectangular region is the same as the plane region 320), margins of a prescribed margin width from edges of the rectangular region and projects a projection content in the projection region 330.

Note that although in what manner the prescribed margin width is set can be arbitrarily determined, a case where a length h is set as a margin width in the horizontal direction and a length v is set as a margin width in the vertical direction is illustrated in FIG. 7. The length h and the length v may be set to, for example, fixed lengths (for example, 5 mm) or may be set to lengths matching size of a plane region (for example, 5% of the horizontal length of the plane region is set as the length h and 5% of the vertical length of the plane region is set as the length v).

In addition, in the present embodiment, a projection content is information for assisting work performed by the user (work guide), as illustrated in, for example, FIG. 4. Since with respect to each work performed by the user, a work guide for the work exists, a plurality of types of work guides (projection contents) exists. Since there are some cases where even for a work guide for the same work, it is desirable to change a layout for projection depending on a shape of a region in which the work guide is projected, a plurality of layouts is prepared for each work guide (as illustrated in, for example, FIGS. 4, 5, and 6). Since the shape and position of the plane region 320 changes depending on a shape and arrangement place of the work object 310 that the user uses in the work, the shape (shape and size) of the projection region 330 accordingly changes. Thus, the controller 110 selects and projects a projection content arranged in a layout that matches the shape of the projection region 330 to the extent possible.

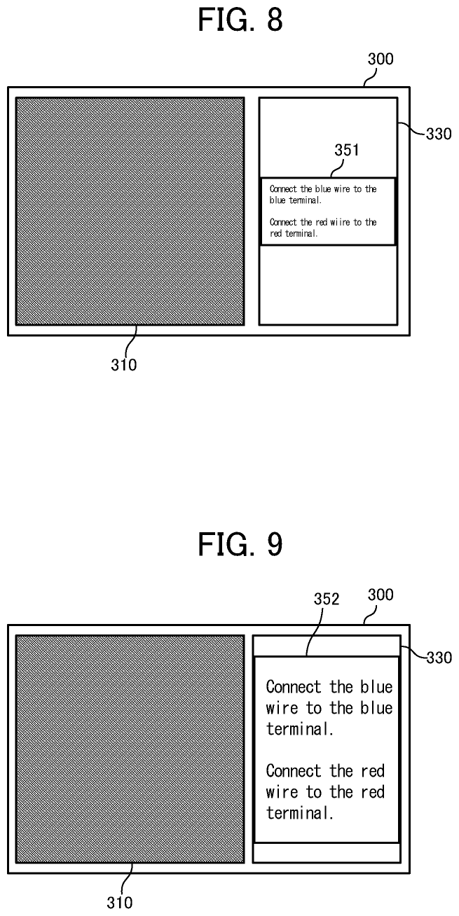

For example, when as illustrated in FIG. 8, the work object 310 exists in a region occupying half the work table 300 or more, the projection region 330 becomes a vertically long rectangle and the controller 110 is caused to project a projection content in the vertically long projection region 330. When the projection content 351 arranged in the horizontally long layout is projected, the controller 110 is required to reduce the projection content 351 in accordance with the horizontal width of the projection region 330, as a result of which characters become small and it becomes difficult to read, as illustrated in FIG. 8. On the other hand, when the projection content 352 arranged in the vertically long layout is projected, the projection content 352 is scarcely reduced even when the projection content 352 is projected in accordance with the horizontal width of the projection region 330, as illustrated in FIG. 9, as a result of which characters do not become small and the projection content 352 is projected in an easily viewable manner.

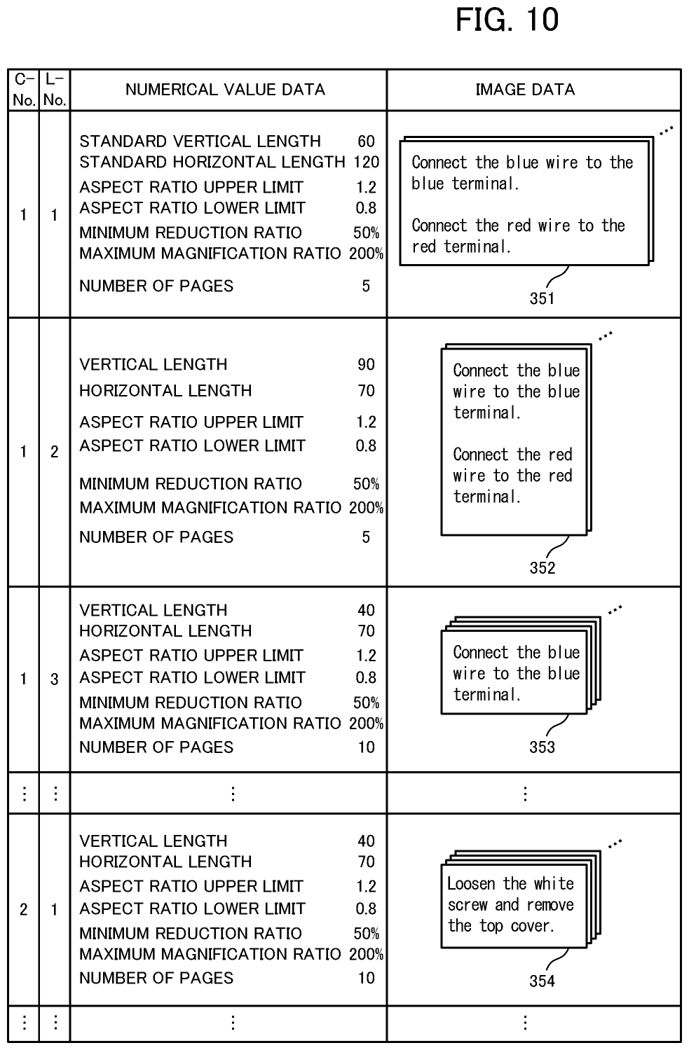

Therefore, the controller 110 selects a layout of a projection content in accordance with the shape (shape and size) of the projection region 330 and projects the projection content in the projection region 330. In order to enable the controller 110 to select a projection content arranged in a layout matching the projection region 330, information about projection contents is stored in the storage 120 in a data structure as illustrated in FIG. 10. That is, as information about a projection content, a content number representing a type of a projection content (type of a work guide) (C-No.), a layout number representing a type of a layout (L-No.), numerical value data, such as size of the layout, (numerical value data), and image data of each page in a projection content arranged in the layout (image data) are stored, as illustrated in FIG. 10.

FIG. 10 illustrates an example in which as numerical value data, vertical length (standard vertical length) and horizontal length (standard horizontal length) of image data, an upper limit (aspect ratio upper limit) and a lower limit (aspect ratio lower limit) of a aspect ratio when each of a magnification ratio of the vertical length and a magnification ratio of the horizontal length of the image data is changed (vertical magnification ratio/horizontal magnification ratio), a reduction ratio when the image data are reduced most (minimum reduction ratio) and a magnification ratio when the image data are magnified most (maximum magnification ratio) without changing the aspect ratio, and the number of pages of the image data (the number of pages) are stored.

As illustrated in FIG. 10, each layout of a projection content is distinguished based on not only the amount of information (the number of characters or the like) per page but also a shape when the projection content is projected. In FIG. 10, examples of a projection content having a content number 1 and examples of a projection content having a content number 2 are illustrated. With regard to the projection content having the content number 1 among the projection contents, examples of the projection content 351 that includes a large amount of information per page (including information in a total of five pages each of which includes five lines of information of 28 characters with spaces per line) and has a horizontally long layout having a layout number 1, the projection content 352 that includes a large amount of information per page (including information in a total of five pages each of which includes eight lines of information of 16 characters with spaces per line) and has a vertically long layout having a layout number 2, and the projection content 353 that includes a small amount of information per page (including information in a total of 10 pages each of which includes three lines of information of 16 characters with spaces per line) and has a small layout having a layout number 3 are illustrated. In addition, with regard to the projection content having the content number 2, an example of a projection content 354 that includes a small amount of information per page (including information in a total of 10 pages each of which includes three lines of information of 16 characters with spaces per line) and has a small layout having a layout number 1 is illustrated.

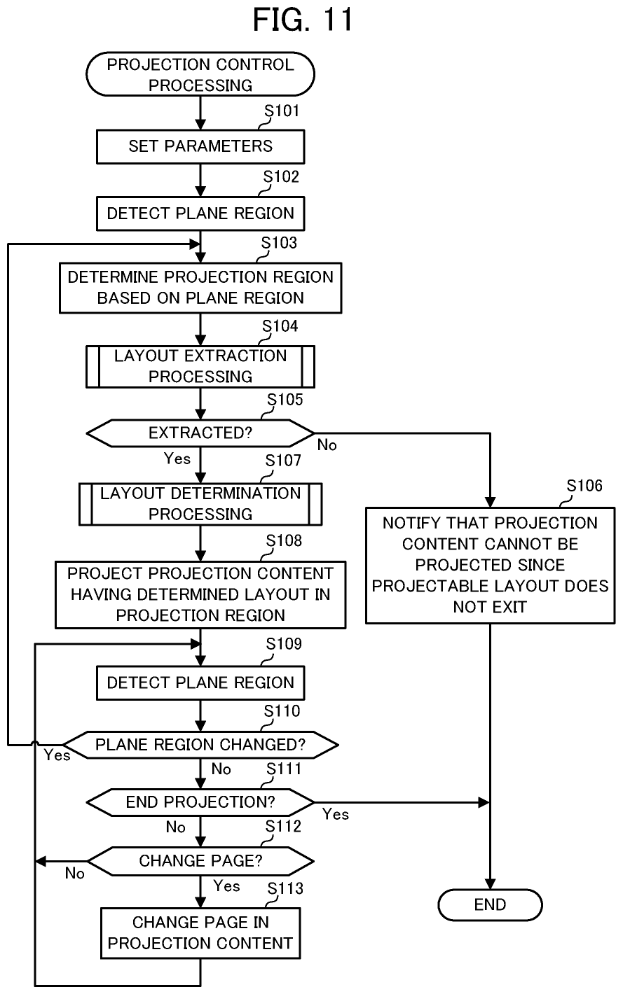

Processing in which, using such numerical value data, the controller 110 selects and projects a projection content arranged in an optimum layout (projection control processing) is described with reference to FIG. 11. Execution of the projection control processing is started when after the projection system 100 has completed the above-described calibration processing, the projector 160 is ready to project a projection content or when the user instructs execution of the projection control processing from the operation inputter 130.

First, the controller 110 sets parameters at the time of projecting a projection content (the content number, the layout number, a page location, and the like of the projection content) (step S101). In this step, the controller 110 sets the parameters by requesting the user to input a content number indicating the type of a work guide that the user desires to project and initializing the layout number and the page location to 1. In addition, for example, by setting the content number, the layout number, and the page location of a projection content that was projected last time, it becomes possible for the controller 110 to project the projection content that was projected last time and for the user to easily refer to the rest of the projection content.

Next, the controller 110 acquires image information (three-dimensional information) of a projection plane, using the detector 150 and, based on the acquired image information, detects a planar region on the projection plane as a plane region (step S102).

The controller 110 determines a projection region, based on the detected plane region (step S103). The controller 110, for example, determines a projection region as a region obtained by excluding, from a largest rectangular region inscribed in the plane region, margins of a prescribed margin width from the edges of the rectangular region. Note that the image information acquired in step S102 may include two-dimensional information as long as the controller 110 is able to determine a projection region. However, when the image information is three-dimensional information, the controller 110 can more accurately detect a planar region on the projection plane.

Next, the controller 110 executes layout extraction processing and extracts, with respect to the projection content set in step S101, a layout that is projectable in the projection region determined in step S103 (step S104). Details of the layout extraction processing is described later.

The controller 110 determines whether or not one or more layouts projectable in the projection region are extracted in the layout extraction processing (step S105).

When no projectable layout is extracted (step S105; No), the controller 110 notifies the user that no projection content having a layout projectable in the projection region exists, using the outputter 140 (step S106) and terminates the projection control processing. The notification to the user may be performed by output of a sound from the speaker, performed by light emission from the LED or the like, or performed by display of the notification on the display.

When one or more projectable layouts are extracted (step S105; Yes), the controller 110 executes layout determination processing and determines a layout of the projection content matching the projection region from among the layouts extracted in the layout extraction processing (step S107). Although details of the layout determination processing is described later, a projection content arranged in a layout that best fits (best matches) the projection region is determined in this processing.

Next, the controller 110 projects the projection content arranged in the layout determined in the layout determination processing in the projection region (step S108). On this occasion, the controller 110 performs the projection at a magnification ratio and a aspect ratio (a vertical length MY and a horizontal length MX that are finally saved in a variable CC, which is described later) that were used when the layout was determined in the layout determination processing. In addition, at the time of first projection after the plane region is determined to have changed in step S110, which is described later, and the controller 110 returns to step S103, the controller 110 also performs processing to correct the page location of the projection content to be projected as needed basis.

The controller 110 performs the same processing as the processing in step S102 and detects a plane region (step S109). Then, the controller 110 determines whether or not the plane region detected in the current round of processing has changed from the plane region when the current projection region was set by a predetermined threshold or more (step S110). When the plane region has changed (step S110; Yes), the controller 110 returns to step S103 and determines a projection region, based on the plane region detected in step S109. Note that change in the plane region means that the shape, size, position, and the like of the plane region change, and in the step in which whether or not the plane region has changed by the predetermined threshold or more is determined, whether or not the size of the plane region has changed by a predetermined threshold or more may be determined or whether or not the shape (for example, a aspect ratio) of the plane region has changed by a predetermined threshold or more may be determined.

When the plane region has not changed (step S110; No), the controller 110 determines whether or not to end the projection (step S111). For example, when the controller 110 acquires an instruction to end the projection control processing through the operation inputter 130, the controller 110 determines to end the projection.

When the controller ends the projection (step S111; Yes), the controller 110 terminates the projection control processing. When the controller does not end the projection (step S111; No), the controller 110 determines whether or not to change the page of the projection content (step S112). For example, when the foot switch 131 is pressed, the controller 110 changes the page.

When the controller 110 does not change the page (step S112: No), the controller 110 returns to step S109. When the controller 110 changes the page (step S112; Yes), the controller 110 changes the page of the projection content being projected (step S113) and returns to step S109. Note that although in what manner an input of a page change is accepted can be arbitrarily determined, the controller 110 changes the page in a forward manner when, for example, the controller 110 detects that the foot switch 131 is pressed. In addition, the controller 110 may accept, for example, a cursor key input from the keyboard of the operation inputter 130 and change the page in such a manner as to, when the input cursor key is a right cursor key, change the page in a forward manner and, when the input cursor key is a left cursor key, change the page in a backward manner.

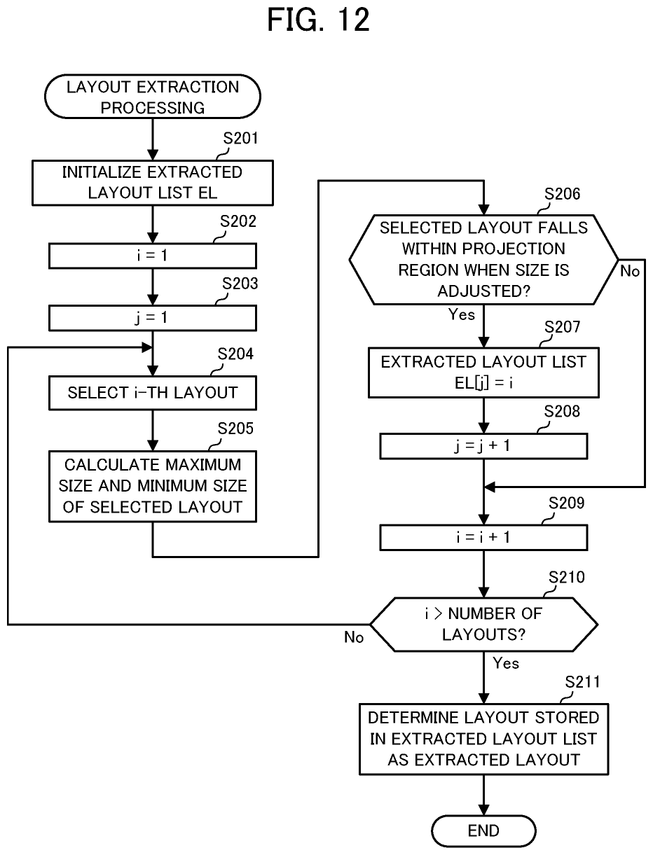

Next, the layout extraction processing executed in step S104 in the projection control processing is described with reference to FIG. 12. Note that in the layout extraction processing, as a variable to save the layout number of an extracted layout, an array variable (a variable in which a plurality of values can be saved) that is referred to as an extracted layout list EL is used.

First, the controller 110 initializes (makes empty) the extracted layout list EL in the storage 120 (step S201). Next, the controller 110 initializes a variable i indicating a layout number to 1 (step S202) and initializes a variable j indicating an element number in the extracted layout list EL to 1 (step S203).

The controller 110 selects a layout having a layout number indicated by the variable i from among layouts stored in the storage 120 as layouts of a projection content having the content number set in step S101 (step S204) and calculates a maximum size and a minimum size of the selected layout (step S205). For example, in the case of image data having a content number C-No. of 1 and a layout number L-No. of 1 in FIG. 10, since the standard vertical and horizontal lengths are 60×120, the maximum magnification ratio is 200%, and the minimum reduction ratio is 50%, the maximum size and the minimum size when the aspect ratio is not changed are 120×240 and 30×60, respectively.

When the aspect ratio upper limit of 1.2 is used to further magnify the layout having the maximum size in the vertical direction, the maximum size becomes 144×240. In addition, when the aspect ratio lower limit of 0.8 is used to further magnify the layout having the maximum size in the horizontal direction, the maximum size becomes 120×300. Conversely, when the aspect ratio lower limit of 0.8 is used to further reduce the layout having the minimum size in the vertical direction, the minimum size becomes 24×60. In addition, when the aspect ratio upper limit of 1.2 is used to further reduce the layout having the minimum size in the horizontal direction, the minimum size becomes 30×50. Therefore, as the maximum size, 144×240 and 120×300 are calculated, and as the minimum size, 24×60 and 30×50 are calculated.

The controller 110 compares the calculated sizes with the size of the projection region and determines whether or not the layout selected in step S204 falls within the size of the projection region with respect to both the vertical length and the horizontal length when the size is adjusted (step S206).

When the layout selected in step S204 does not fall within the size of the projection region even when the size is adjusted (step S206; No), the controller 110 proceeds to step S209. In contrast, when the layout selected in step S204 falls within the size of the projection region when the size is adjusted (step S206; Yes), the controller 110 stores a value of the variable i (the layout number of the layout selected in step S204) in EL[j] that is the j-th element in the extracted layout list EL (step S207) and increases a value of the variable j by one (step S208).

The controller 110 increases the value of the variable i by one (step S209) and determines whether or not the value of the variable i exceeds the number of layouts stored in the storage 120 as the layouts of the projection content having the content number set in step S101 (step S210). When the value of the variable i does not exceeds the number of layouts (step S210; No), the controller 110 returns to step S204, selects a layout having the next layout number, and repeats the above-described processing.

When the value of the variable i exceeds the number of layouts (step S210: Yes), the controller 110 determines layouts stored in the extracted layout list EL as extracted layouts (step S211) and terminates the layout extraction processing.

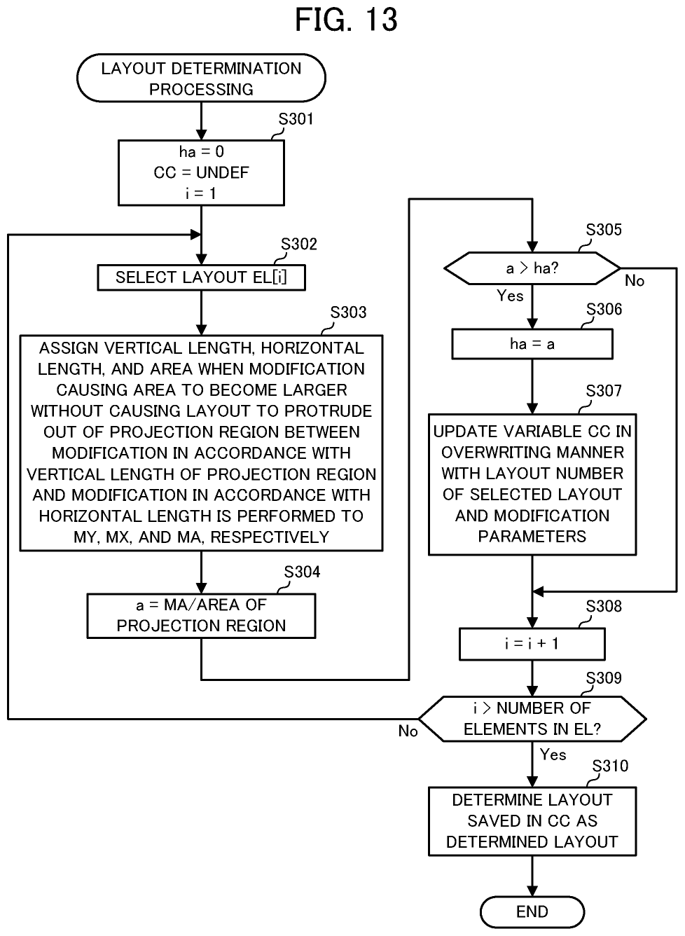

Next, the layout determination processing executed in step S107 in the projection control processing is described with reference to FIG. 13. Note that in the layout determination processing, a variable ha and a variable CC are used as variables to be used to determine a layout. The variable ha is a variable for saving a maximum value among values each calculated by “area of a layout divided by area of the projection region” with respect to one of layouts having been selected up to that time in order to determine a layout that has area as close as possible to the area of the projection region. In addition, the variable CC is a variable for saving the layout number and modification parameters (vertical length MY, horizontal length MX, and area MA) of a candidate layout for determination. In addition, the extracted layout list EL, which is an array variable in which the layout numbers of layouts extracted by the layout extraction processing are stored, and the variable i, which indicates an element number in the extracted layout list EL, are also used.

First, the controller 110 initializes the variable ha to 0, initializes the variable CC to UNDEF (undefined), and initializes the variable i indicating the element number of the extracted layout list EL to 1 (step S301).

The controller 110 selects a layout having a layout number indicated by the i-th element EL[i] in the extracted layout list EL (step S302).

The controller 110 calculates a vertical length, a horizontal length, and an area of a modified layout when modification of the shape of the selected layout that causes the area of the layout to become larger without causing the layout to protrude out of the projection region between modification in accordance with the vertical length of the projection region and modification in accordance with the horizontal length of the projection region is performed, and assigns the calculated vertical length, horizontal length, and area to the variable MY, the variable MX, and the variable MA, respectively (step S303).

For example, a case where the size of the selected layout is vertical and horizontal lengths of 60×120, both the aspect ratio upper limit and the aspect ratio lower limit are 1.0, the maximum magnification ratio is 200%, and the size of the projection region is vertical and horizontal lengths of 120×180 is described. In this case, although the size of a layout when magnification to 200% in length is performed in accordance with the vertical length of the projection region (in such a way that the vertical length of the layout after magnification coincides with the vertical length of the projection region) becomes vertical and horizontal lengths of 120×240, the layout can be magnified only to 150% at most since the horizontal length of the layout when magnified to 200% in length exceeds the horizontal length of the projection region, which is 180, and the size of a layout when magnified to 150% in length becomes vertical and horizontal lengths of 90×180. In addition, the size of a layout when magnification to 150% in length is performed in accordance with the horizontal length of the projection region (in such a way that the horizontal length of the layout after magnification coincides with the horizontal length of the projection region) becomes vertical and horizontal lengths of 90×180. Therefore, in the case of this example, the maximum size when the layout is modified becomes vertical and horizontal lengths of 90×180, and to the variable MY, the variable MX, and the variable MA, 90, 180, and 90×180=16200 are assigned.

Next, the controller 110 assigns a value obtained by dividing the value of the variable MA by the area of the projection region to a variable a (step S304) and determines whether or not a value of the variable a is greater than a value of the variable ha (step S305). When the value of the variable a is less than or equal to the value of the variable ha (step S305; No), the controller 110 proceeds to step S308.

When the value of the variable a is greater than the value of the variable ha (step S305; Yes), the controller 110 assigns the value of the variable a to the variable ha (step S306). Then, the controller 110 updates the variable CC in an overwriting manner with the layout number of the layout selected in step S302 and the modification parameters (the vertical length MY, the horizontal length MX, and the area MA) calculated in step S303 in the current round of processing (step S307).

The controller 110 increases the value of the variable i by one (step S308) and determines whether or not the value of the variable i exceeds the number of layouts that are extracted in the layout extraction processing (the number of elements in the extracted layout list EL) (step S309). When the value of the variable i does not exceeds the number of extracted layouts (step S309; No), the controller 110 returns to step S302, selects the next layout stored in the extracted layout list EL, and repeats the above-described processing.

When the value of the variable i exceeds the number of extracted layouts (step S309: Yes), the controller 110 determines a layout stored in the variable CC (updated in an overwriting manner last time) as a determined layout (step S310) and terminates the layout determination processing.

Note that although in the above-described layout determination processing, when the controller 110 determines a layout of a projection content to be projected in the projection region, the controller 110 determines a layout that can be projected as large as possible by modifying the shape of the layout of the projection content, a criterion for determination of a layout of a projection content is not limited thereto. For example, a layout of the projection content that falls within the projection region while having the standard size without being modified to the extent possible and further has area closest to the area of the projection region among such layouts of the projection content may be determined as the layout of the projection content to be projected in the projection region.

Since by the projection control processing, the layout extraction processing, and the layout determination processing that are described above, the controller 110 determines a projection region, based on image information of the projection plane and determines a layout of a projection content according to the shape of the determined projection region, the projection content can be projected in the projection region in an easily viewable manner. Since an image processing device disclosed in Unexamined Japanese Patent Application Publication No. 2013-254437 described above projects work assistance information, based on position information of a document on a projection region acquired by a camera while keeping a relative positional relationship between the work assistance information and the document on the projection region, the image processing device is capable of improving work efficiency of a user. However, since what is taken into consideration when the work assistance information is projected is only a relative positional relation between the work assistance information and the document, there has been a problem in that depending on a shape and size of a region in which the work assistance information is projected, it becomes difficult to view the work assistance information. In contrast, according to the present disclosure, by determining a layout of a projection content to be projected according to the shape of a projection region, the projection content can be projected in an easily viewable manner.

In addition, when a plane region in the projection plane changes, the controller 110 determines a projection region, based on the plane region after change and, based on a change in the shape of the projection region, changes a layout of a projection content to be projected in the projection region. Therefore, even when the shape of the projection region changes, the projection content can be projected in the projection region in an easily viewable manner.

In addition, since when image information acquired by the detector 150 is three-dimensional information, the controller 110 can more accurately detect a plane region and determine a projection region, based on a more accurate plane region, the projection content can be projected in the projection region in an easily viewable manner.

In addition, the controller 110 determines a layout of a projection content to be projected in a projection region according to the shape and size of the projection region. That is, the controller 110 determines the amount of information per page of a projection content according to the size of the projection region. Thus, since when the projection region is small, a projection content having a small amount of information per page is selected, projected characters and the like are not reduced in size and the projection content can be projected in an easily viewable manner.

In addition, the controller 110 determines a projection region as a region obtained by excluding, from a largest rectangular region inscribed in a detected plane region, margins of a prescribed margin width from the edges of the rectangular region. Since by determining a projection region in such a manner because the shape of a region in which a projection content is projected by the projector 250 is rectangular, the projection content can be projected as large as possible and an appropriate margin can be kept in a space to a region in which a work object and the like exist, the projection content can be projected in an easily viewable manner. Note that the controller 110 may determine a detected plane region as a projection region with the prescribed margin width set to 0. By determining a projection region in this way, the controller 110 can project a projection content as large as possible.

In addition, when no layout that is projectable in the projection region exists, the controller 110 notifies the user of that fact (that no projection content having a layout projectable in the projection region exists), using the outputter 140. Because of this configuration, when a projection content is not projected, the user can notice that the plane region is so small that the projection content cannot be projected.

In addition, since the controller 110 determines a layout of a projection content according to the shape of a projection region, it becomes unnecessary to magnify or reduce or modify the shape of a projection content more than necessary and the projection content can be projected in an easily viewable manner.

### Embodiment 2

In Embodiment 1 described above, a projection content is only projected in a projection region and when acquiring an operation of the user, the controller 110 is required to acquire the operation through the operation inputter 130. However, since the projection system 100 includes the detector 150, the projection system 100 can also acquire a gesture of the user by the detector 150. Embodiment 2 in which an element by which a user can input an operation (an operation target, such as a button) is added to a projection content and the user can perform an operation through a gesture (for example, a gesture of pressing a button) on a projection region in which the projection content is projected is described.

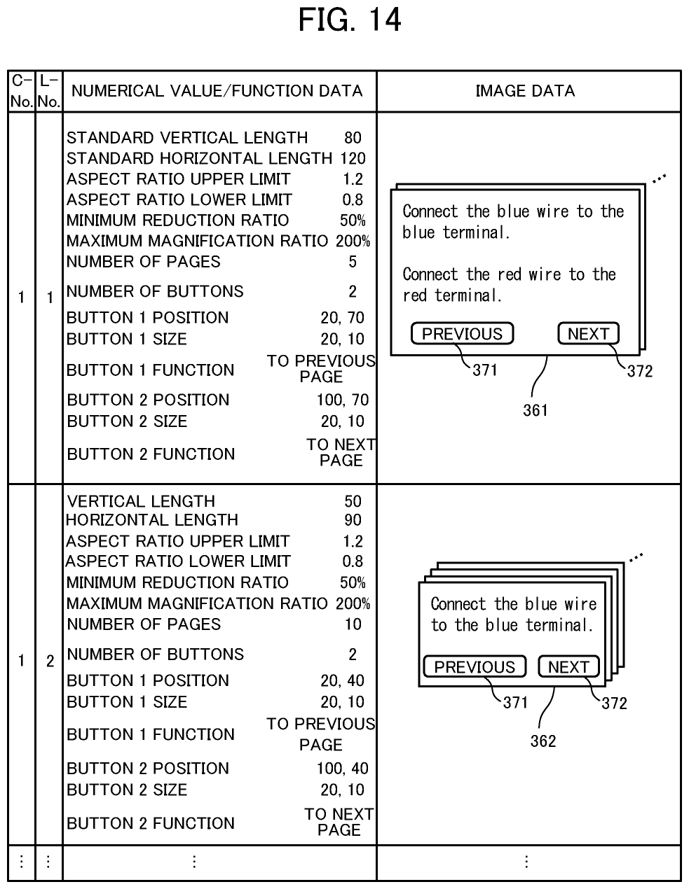

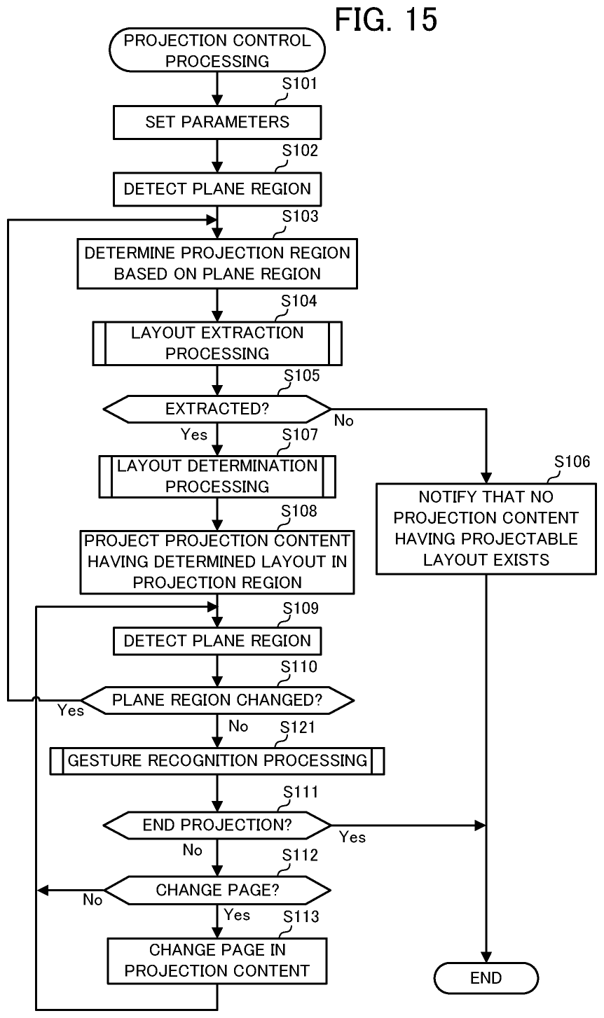

In Embodiment 2, an operation target is included in a projection content. For example, in an example illustrated in FIG. 14, among projection contents having a content number 1, a projection content 361 arranged in a layout having a layout number 1 includes, as operation targets, a button 371 to return a page to a previous page and a button 372 to advance the page to a next page in image data. Likewise, a projection content 362 arranged in a layout having a layout number 2 also includes, as operation targets, the button 371 to return a page to a previous page and the button 372 to advance the page to a next page in image data. In a storage 120, as illustrated in FIG. 14, a content number representing a type of a projection content (C-No.), a layout number representing a type of a layout (L-No.), information about size of the layout, positions of buttons, and the like (numerical value/function data), and image data in which an operation target in the projection content arranged in the layout is also depicted (image data) are stored.

FIG. 14 illustrates an example in which in addition to numerical value data similar to the numerical value data in Embodiment 1, the number of buttons, a position of each button, size of each button, and a function of each button (processing assigned to the button) are stored as the numerical value/function data. Because of this configuration, when the user performs a gesture (for example, a gesture of pressing a button) on an operation target (for example, a button) included in a projected projection content, a controller 110 can execute processing (for example, advancing to a next page) assigned to the gesture.

Projection control processing according to Embodiment 2 is processing in which, in order to include such a gesture recognition function, gesture recognition processing (step S121) is added between step S110 and step S111 in the projection control processing (FIG. 11) according to Embodiment 1, as illustrated in FIG. 15. Note that since layout extraction processing and layout determination processing according to Embodiment 2 are the same as the layout extraction processing and the layout determination processing according to Embodiment 1 and are performed as illustrated in FIGS. 12 and 13, respectively, descriptions thereof will be omitted.

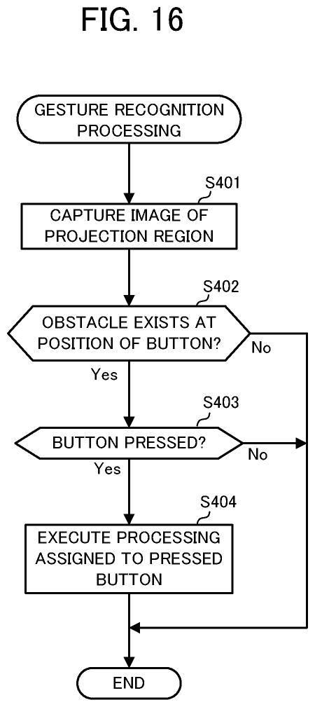

The gesture recognition processing executed in step S121 in the projection control processing according to Embodiment 2 (FIG. 15) is described with reference to FIG. 16.

First, the controller 110 captures an image of a projection region by a detector 150 (step S401) and determines whether or not an obstacle exists at a position of a button in a projection content projected in the projection region (step S402). That is, the controller 110 obtains an XY coordinates of the button from “button position” and “button size” in the numerical value/function data as illustrated in FIG. 14, acquires a depth (distance in the depth direction to an obstacle or a projection plane) at the XY coordinates, and determines whether or not an obstacle exists, based on a magnitude of the acquired depth. When no obstacle exists at the position of the button (step S402; No), the controller 110 terminates the gesture recognition processing.

When an obstacle exists at the position of the button (step S402; Yes), the controller 110 determines whether or not the button is pressed (step S403). When the controller 110 detects that the obstacle exists on the projected button for a certain period (one second), the controller 110 determines that the button is pressed. Alternatively, the controller 110 calculates, based on three-dimensional information acquired by the detector 150, a distance from the detector 150 to the obstacle, and when a difference between the distance and distance from the detector 150 to the button is less than a predetermined value (for example, 1 cm), may determine that the button is pressed.

When the button is not pressed (step S403; No), the controller 110 terminates the gesture recognition processing. When the button is pressed (step S403; Yes), the controller 110 executes processing assigned to the pressed button (step S404) and terminates the gesture recognition processing.

In the above-described gesture recognition processing, the controller 110 acquires information about a type of the pressed button and processing assigned to the pressed button from information about the projection content as illustrated in FIG. 14 that is stored in the storage 120. Note that although when modification processing, such as magnification and reduction and change of an aspect ratio, is performed at the time of projection of a projection content in the projection region, the position and size of the button is caused to be changed in response to the modification processing, the controller 110, in this case, performs, based on information about the position and size of the button and the like after change, determination of whether or not the button is pressed.

In Embodiment 2, information for recognizing a gesture (gesture recognition information) is included in information about a projection content stored in the storage 120, and the controller 110 performs the gesture recognition processing, using the gesture recognition information and information acquired by the detector 150 and is capable of performing processing matching a recognized gesture. Therefore, a projection system according to Embodiment 2 is capable of not only simply projecting a projection content in a projection region but also improving operability on this occasion.

### Embodiment 3

In the above-described embodiments, data of a projection content projected in a projection region are image data. Although therefore, when a layout of a projection content is determined, the layout can be slightly changed by magnification and reduction and change in an aspect ratio, substantial modification, such as modifying a vertically long layout to a horizontally long layout, cannot be performed and the amount of information displayed in each page also cannot be changed. However, when a projection content is represented by text data, it becomes possible to project the projection content in the form of feeding the text into a region without depending on a shape of the projection region. Embodiment 3 in which a projection content is stored as text data instead of image data is described. Note that it is assumed that an image formed by feeding text data into a given region is referred to as a reflow image and projection in such a reflow image is referred to as “projection in a reflow form”.

In Embodiment 3, a projection content is text data and includes information about a “line feed” and a “page feed” as needed basis. In Embodiment 3, since a layout of a projection content is determined by the projection content being fed into a projection region (that is, by generating a reflow image, a layout of the projection content is determined), a plurality of layouts does not have to be prepared with respect to the same projection content as in Embodiment 1. In other words, for each projection content, only a piece of text data having a layout number 1 may be prepared.

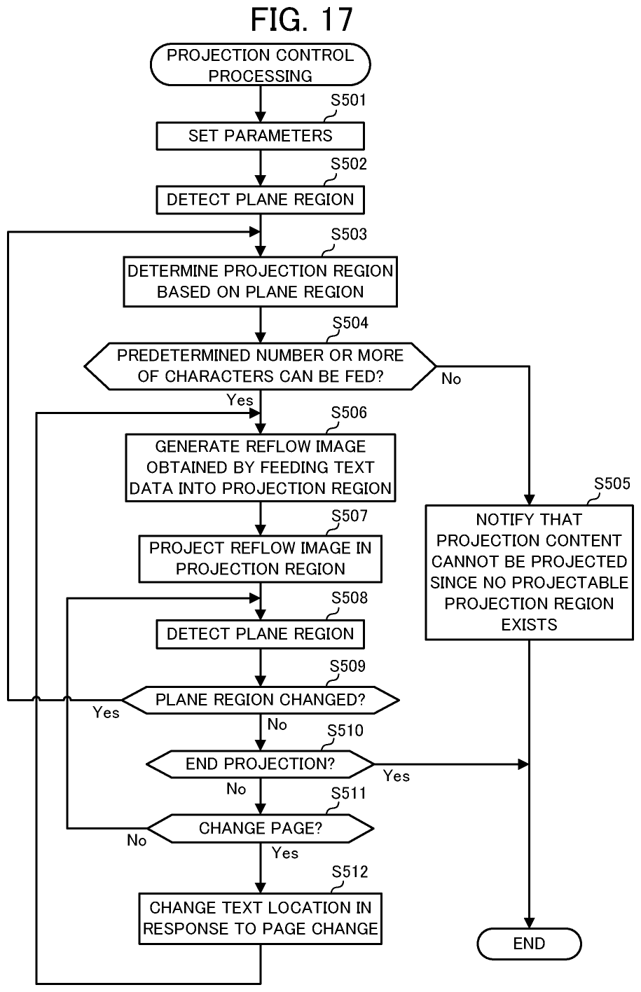

Projection control processing according to Embodiment 3 is described below with reference to FIG. 17. First, a controller 110 sets parameters at the time of projecting a projection content (a content number of the projection content, a location of a text to be fed into the projection region, and the like) (step S501). Although processing in this step is similar processing to the processing in step S101 in the projection control processing (FIG. 11) according to Embodiment 1, projection data basically have no concept of page since a projection data is not image data but text data, in Embodiment 3. Therefore, in the parameter setting in this step, a “text location” is set in place of a “page location” in Embodiment 1. The text location is a parameter indicating from what location in the text data are fed into a projection region, and an initial value of the text location is 0.

For example, it is assumed that when in the case where text data are “Connect the blue wire to the blue terminal” and the text location is 0, the text data of the projection content are fed into a projection region, a portion of the text data equivalent to 24 characters (“Connect the blue wire to”) are able to be fed into the projection region. Then, the text location when a processed page advances to a next page becomes 24 (since the number of characters that were fed into the projection region before the advancement is added).

Since processing in succeeding steps S502 to S503 is the same as the processing in steps S102 to S103 in the projection control processing (FIG. 11) in Embodiment 1, a description thereof is omitted. In step S504, the controller 110 determines whether or not text data of a predetermined number (for example, 24 characters with spaces) or more of characters can be fed into the projection region determined in step S503. Regarding a method for the determination, when it is assumed that size of one character is denoted by horizontal and vertical sizes CX×CY, size of a projection region is denoted by horizontal and vertical sizes RX×RY, and a function to round down decimal places of an argument V is denoted by INT (V), it is possible to feed text data of a predetermined number or more of characters into the projection region when the following equation is satisfied:

$$INT ( RX / CX ) \times INT ( RY / CY ) \geq the predetermined number of characters . \qquad ( 1 )$$

Therefore, in step S504, the controller 110, for example, makes a determination, based on the above-described equation (1).

When only text data of less than the predetermined number of characters can be fed into the projection region (step S504; No), the controller 110 notifies a user that the projection content cannot be projected since no projection region that allows the projection content to be projected exists, using an outputter 140 (step S505) and terminates the projection control processing. This is because there is a high possibility that when only text data of less than the predetermined number of characters can be fed into the projection region, no content enabling the user to grasp the content as a sentence meaningful for the user can be projected.

When text data of the predetermined number or more of characters can be fed into the projection region (step S504; Yes), the controller 110 generates a reflow image that is obtained by feeding the text data into the projection region (a region equivalent to the shape and size of the projection region) from a current text location (step S506). Then, the controller 110 projects the generated reflow image in the projection region (step S507). Since processing in succeeding steps S508 to S511 is the same as the processing in steps S109 to S112 in the projection control processing (FIG. 11) in Embodiment 1, a description thereof is omitted. However, when determination in step S509 results in Yes, the controller 110 returns to step S503, and when determination in step S511 results in No, the controller 110 returns to step S508.

In step S512, the controller 110 changes the text location in response to a page change and returns to step S506. In the change in the text location in step S512, the controller 110, when changing the page to a next page, increases the text location by the number (for example, 24) of characters with spaces that were fed into the projection region when the reflow image currently being projected was generated (for example, the text location is changed from 0 to 24). In addition, every time the controller 110 changes the text location in the forward direction (to the next page), the controller 110 may save a change history of the change in a storage 120. By performing processing in this way, when the controller 110 changes the page to a previous page, the controller 110 is only required to track the change history of the text location in the backward direction.

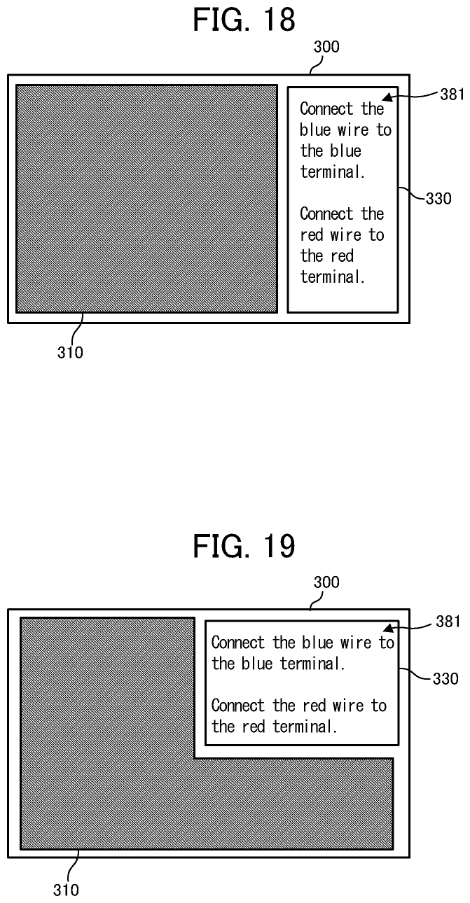

Since by performing such processing, the controller 110 projects a reflow image obtained by feeding text data of a projection content into a projection region, the controller 110 can project the projection content according to the shape of the projection region in an easily viewable manner. For example, while when as illustrated in FIG. 18, a work object 310 exists in such a manner as to occupy a left half or more of a work table 300, a vertically long projection region 330 is obtained, the controller 110, by generating and projecting a reflow image obtained by feeding text data of a projection content 381 into the projection region, projects the projection content 381 in the projection region 330 in the reflow form, as illustrated in FIG. 18.

In addition, for example, while when a work object 310 exists on the work table 300 as illustrated in FIG. 19, a horizontally long projection region 330 is obtained, the controller 110, by generating and projecting a reflow image obtained by feeding text data of a projection content 381 into the projection region, projects the projection content 381 in the projection region 330 in the reflow form, as illustrated in FIG. 19.

As evident when comparing FIGS. 18 and 19, although both projection contents 381 to be projected are, as text data, the same “Connect the blue wire to the blue terminal, [line feed] [line feed] Connect the red wire to the red terminal”, a form of projection of the projection contents 381 changes according to a shape of the projection region 330 since the projection contents 381 are projected in the reflow form. In other words, when compared with Embodiments 1 and 2, it is not necessary to prepare a plurality of types of layouts for a projection content according to the shape of the projection region, in Embodiment 3. In addition, in Embodiment 3, the controller 110 generates a reflow image by feeding text data serving as a projection content into a region having a shape and size equivalent to the shape and size of a projection region and determines a layout of the projection content by generating the reflow image. Therefore, projection contents can be stored in the storage 120 more efficiently. In addition, since by projecting a projection content in the reflow form, the projection content can be projected in a flexible manner according to a region in which the projection content is projected, projection contents can be projected in an easily viewable manner without depending on the shape of a projection region.

Note that when as information about a projection content, not only text data but also information about a type of a character font, character size, an upper limit and a lower limit of the character size, an upper limit and a lower limit of inter-character spacing, an upper limit and a lower limit of inter-line spacing, and the like is stored, the controller 110 may, taking into consideration the size of a projection region and the above-described information, determine optimum text data, optimum character size, optimum inter-character spacing, and optimum inter-line spacing.

In Embodiment 3, by storing a projection content represented by text data in the storage 120, the controller 110 can project the text data in a projection region in the reflow form. Since because of this capability, characters included in the projection content are appropriately arranged according to the shape of the projection region, a projection system according to Embodiment 3 is capable of projecting a projection content in an easily viewable manner.

### Variations

Although in the above-described embodiments, a projection region is assumed to be a region obtained by excluding, from a largest rectangular region inscribed in a detected plane region, margins of a prescribed margin width from the edges of the rectangular region, the projection region is not limited to such a rectangle and may be set to an arbitrary shape. For example, in some cases, a plane region is not formed in a shape close to a rectangle, depending on the type of a work object, and area of a largest rectangular region inscribed in the plane region becomes extremely small. In such a case, the controller 110 may set a projection region to a shape close to the shape of the plane region. In addition, the controller 110 may set the projection region to, for example, a shape some part of which has a recess as a recessed shape, a shape some part of which has a protrusion as a protruding shape, or the like.

### Other Variations

Note that the projection system 100 can be achieved as not only a system including the PC 210, the 3D camera 240, and the projector 250 but also a system including only the projector 250 including a ranging function or a system including the 3D camera 240 and the projector 250. In addition, although in the above-described embodiments, the description is made assuming that the PC 210 includes the controller 110, it may be configured such that, for example, the projector 250 includes the controller 110, the storage 120, the operation inputter 130, and the outputter 140 and the entire control of the projection system 100 is performed by the controller 110 that the projector 250 includes. In this case, the controller 110, the storage 120, the operation inputter 130, and the outputter 140 in the projector 250 constitute the projection control device 200, and the light source, the projection device, and the lens unit in the projector 250 constitute the projector 160.

In addition, as the PC 210 serving as the projection control device 200, not only a general PC but also an arbitrary computer can be used as long as the computer is a computer including the controller 110, the storage 120, the operation inputter 130, and the outputter 140. The projection control device 200 may be, for example, a one-board microcomputer.

In addition, in the above-described embodiments, the description is made assuming that a program achieving the projection control processing and the like that the controller 110 executes is stored in the storage 120 in advance. However, a computer capable of executing the above-described processing may be configured by storing and distributing a program in a non-transitory computer-readable recording medium, such as a flexible disk, a compact disc read only memory (CD-ROM), a digital versatile disc (DVD), a magneto-optical disc (MO), a memory card, and a USB memory, and reading and installing the program into the computer.

Further, it is also possible to superimpose a program on a carrier wave and apply the program via a communication medium, such as the Internet. For example, the program may be posted on a bulletin board system (BBS) on a communication network and distributed via the communication network. It may be configured such that the above-described processing can be executed by starting up and executing the distributed program in a similar manner to other application programs under the control of the operating system (OS).

In addition, the controller 110 may be configured not only by an arbitrary processor, such as a single processor, multiple processors, and a multi-core processor, alone but also by combining such an arbitrary processor and a processing circuit, such as an application specific integrated circuit (ASIC) and a field-programmable gate array (FPGA).

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A projection control device including a processor to execute processing comprising:
determining a projection region, based on image information of a projection plane; and
determining a layout of a projection content to be projected in the projection region according to at least a shape of the determined projection region.

2. The projection control device according to claim 1, wherein the processor changes a layout of the projection content, based on a change in a shape of the projection region.

3. The projection control device according to claim 1, wherein
the image information is three-dimensional information, and
the processor
detects, based on the three-dimensional information, a planar region on the projection plane as a plane region, and
determines the projection region, based on the detected plane region.

4. The projection control device according to claim 2, wherein
the image information is three-dimensional information, and
the processor
detects, based on the three-dimensional information, a planar region on the projection plane as a plane region, and
determines the projection region, based on the detected plane region.

5. The projection control device according to claim 1, wherein the processor
determines a layout of the projection content according to a shape and size of the projection region, and
determines an amount of information per page of the projection content according to size of the projection region.

6. The projection control device according to claim 2, wherein the processor
determines a layout of the projection content according to a shape and size of the projection region, and
determines an amount of information per page of the projection content according to size of the projection region.

7. The projection control device according to claim 3, wherein the processor
determines a layout of the projection content according to a shape and size of the projection region, and
determines an amount of information per page of the projection content according to size of the projection region.

8. The projection control device according to claim 3, wherein the processor determines the projection region as a region obtained by excluding, from a largest rectangular region inscribed in the plane region, margins of a prescribed margin width from edges of the rectangular region.

9. The projection control device according to claim 4, wherein the processor determines the projection region as a region obtained by excluding, from a largest rectangular region inscribed in the plane region, margins of a prescribed margin width from edges of the rectangular region.

10. The projection control device according to claim 1, wherein the processor, when the layout projectable in the projection region does not exit, notifies that fact.

11. The projection control device according to claim 1, wherein
the projection content includes information about an operation target, and
the processor
determines whether or not an operation is performed on the operation target, and
when an operation is performed on the operation target, executes processing matching an operation on the operation target.

12. The projection control device according to claim 1, wherein the processor
generates a reflow image by feeding text data serving as the projection content into a region having a shape and size equivalent to a shape and size of the projection region, and
determines a layout of the projection content by generating the reflow image.

13. A projection system, comprising:
the projection control device according to claim 1;
a detector to detect the image information of the projection plane; and
a projector to project the projection content on the projection plane in a layout that the processor of the projection control device determines.

14. A projection control method, comprising a processor:
determining a projection region, based on image information of a projection plane; and
determining a layout of a projection content to be projected in the projection region according to at least a shape of the determined projection region.

15. A non-transitory computer-readable recording medium storing a program to cause a processor to execute processing comprising:
determining a projection region, based on image information of a projection plane; and
determining a layout of a projection content to be projected in the projection region according to at least a shape of the determined projection region.
